(19) United States
(12) Patent Application Publication
(10) Pub. No.: US 2026/0093075 A1
(43) Pub. Date: Apr. 2, 2026

(54) OPTICAL FIBER CONNECTOR

(71) Applicant: Gloriole Electroptic Technology Corp., Kaohsiung City (TW)

(72) Inventors: Hsien-Hsin HSU, Kaohsiung City (TW); Yu-Cheng CHEN, Kaohsiung City (TW); Jim LIN, Kaohsiung City (TW)

(21) Appl. No.: 18/967,724

(22) Filed: Dec. 4, 2024

(30) Foreign Application Priority Data
Sep. 27, 2024 (TW) 113210551

(51) Int. Cl. G02B 6/38

(52) U.S. Cl. CPC G02B 6/3874

(57) ABSTRACT

An optical fiber connector includes a casing body, a housing, a tail sleeve, and an auxiliary member. The casing body includes a case wall portion and an engaging portion extending inclinedly from the case wall portion and being flexible. The housing includes two seat members removably mounted to the casing body and detachably connected to each other. The auxiliary member includes a base portion mounted on the tail sleeve and a drive portion extending from the base portion along a longitudinal axis and driving movement of the engaging portion. The auxiliary member is co-movable with the tail sleeve when the tail sleeve is pulled away from the casing body along the longitudinal axis such that the drive portion drives the engaging portion to move toward the case wall portion.

### CROSS-REFERENCE TO RELATED APPLICATION

This application claims priority to Taiwanese Utility Model Patent Application No. 113210551, filed on Sep. 27, 2024, the entire disclosure of which is incorporated by reference herein.

### FIELD

The present disclosure relates to an optical fiber connector, and more particularly to an optical fiber connector that is easy to be inserted into and removed from an optical fiber.

### BACKGROUND

Referring to FIGS. 1 to 3, a conventional optical fiber connector 1 includes a casing body 11, a head sleeve 12 positioned in the casing body 11, two core heads 13 mounted between the casing body 11 and the head sleeve 12 and spaced apart from each other in a top-bottom direction, a tail sleeve 14 detachably connected to a rear end of the casing body 11, a handling lever 15 disposed on the casing body 11 and extending rearwardly, and two engaging members 16 protruding upwardly from a top surface of the casing body 11. To detach the optical fiber connector 1 from an adaptor or a socket (not shown) into which the conventional optical fiber connector 1 is inserted, the casing body 11 is pulled outwardly with a force, such that the engaging members 16 are forced to be disengaged from engaging slots of the adaptor or the socket. However, such detaching manner may easily cause wear of the engaging members 16 or the slots due to forcible pulling of the casing body 11, and the engaging members 16 may even be broken.

The user may pull the handling lever 15 upwardly so the handling lever 15 and the casing body 11 are slightly deformed and moved away from the engaging members 16, thereby causing the engaging members 16 to be disengaged from the slots. However, the abovementioned operation manner is not specifically designed for detaching the conventional optical fiber connector 1, so relative movement between each of the engaging members 16 and the handling lever 15 may be insufficient to allow detachment of the engaging members 16 from the slots. Furthermore, since a plurality of the conventional optical fiber connectors 1 are usually arranged in a matrix and are disposed in a small space, the handling lever 15 of each of the conventional optical fiber connectors 1 may be blocked by another one of the optical fiber connectors 1 or the slots, and is thus difficult to be pulled upwardly to allow detachment of the engaging members 16.

In addition, in the technical field of fiber optic communication, in order to reduce energy transmission loss, surface grinding or angular grinding are usually performed on end surfaces of the core heads 13 so as to reduce reflection angles of optical signals transmitted therein. The abovementioned grinding step must be performed together with optical fibers that are disposed in and connected to the core heads 13, such that angles of the end surfaces of the core heads 13 are respectively consistent with angles of end surfaces of the optical fibers disposed therein. However, since the head sleeve 12 of the conventional optical fiber connector 1 is designed as one piece, it is necessary to assemble the head sleeve 12 and the core heads 13 together first, and then insert the optical fibers respectively into the core heads 13 as depicted in FIG. 3. Hereafter, the core heads 13 and the optical fibers are subsequently ground. In a case where the grinding quality is poor, it is troublesome to disassemble and reassemble the conventional optical fiber connector 1. Furthermore, the conventional optical fiber connector 1 may be damaged by the abovementioned grinding method and thus may be discarded.

### SUMMARY

Therefore, an object of the disclosure is to provide an optical fiber connector that can alleviate at least one of the drawbacks of the prior art.

According to an aspect of the present disclosure, an optical fiber connector includes a casing body, a housing, a tail sleeve, and an auxiliary member. The casing body includes a case wall portion, a partition portion, and an engaging portion. The case wall portion defines an accommodating space therein. The partition portion is disposed in the accommodating space, and is connected to the case wall portion. The engaging portion extends inclinedly from the case wall portion away from the accommodating space, is flexible, extends substantially along a longitudinal axis, and has a distal end that is distal from and movable relative to the case wall portion along the height axis perpendicular to the longitudinal axis. The partition portion and the case wall portion cooperatively define two insertion holes that are in spatial communication with the accommodating space, and that are arranged along a height axis perpendicular to the longitudinal axis. The housing includes two seat members removably mounted to the casing body, and detachably connected to each other. The seat members cooperatively define two mounting grooves that are arranged along the height axis, and that are in spatial communication with the accommodating space. The mounting grooves are respectively aligned with the insertion holes along the longitudinal axis. The tail sleeve includes a receiving portion and a cover portion. The receiving portion is mounted to the seat members and is slidable along the longitudinal axis. The cover portion extends from the receiving portion along the longitudinal axis in a direction away from the casing body. The auxiliary member includes a base portion and a drive portion. The base portion is mounted on the tail sleeve. The drive portion extends from the base portion along the longitudinal axis and drives movement of the distal end of the engaging portion. The auxiliary member is co-movable with the tail sleeve when the tail sleeve is pulled away from the casing body along the longitudinal axis, such that the drive portion drives the distal end of the engaging portion to move toward the case wall portion along the height axis.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic side view of a conventional optical fiber connector.

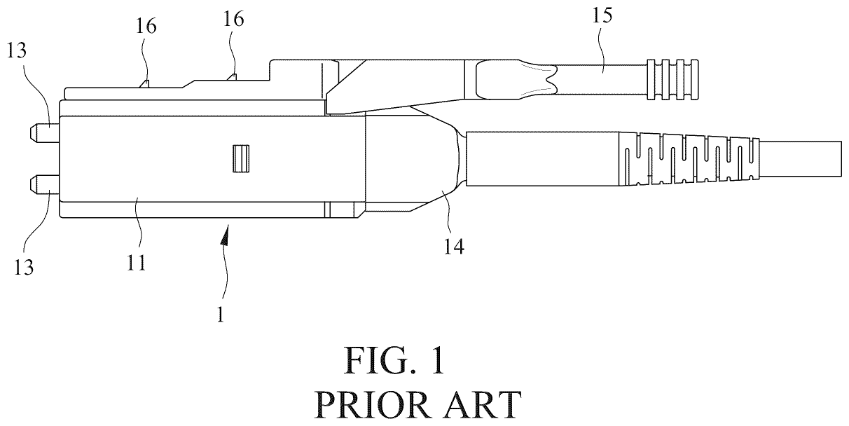

FIG. 2 is a partly exploded perspective view illustrating the structure of the conventional optical fiber connector shown in FIG. 1.

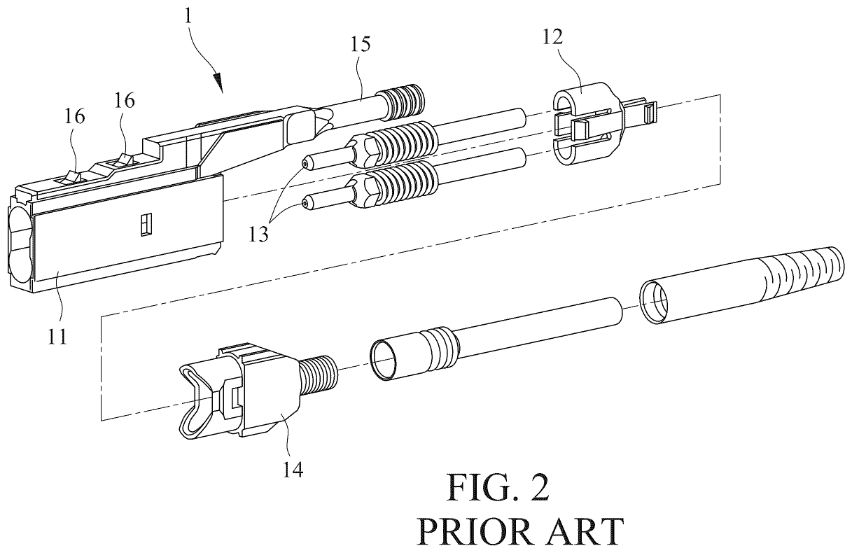

FIG. 3 is a fragmentary cutaway perspective view of some components of the conventional optical fiber connector shown in FIG. 1.

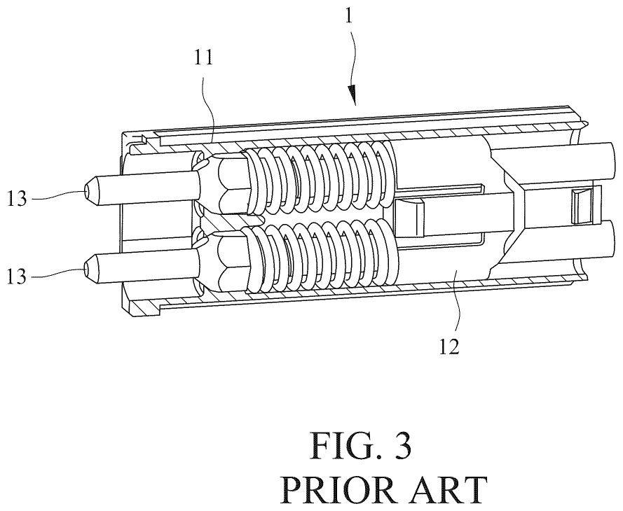

FIG. 4 is a perspective view of an embodiment of an optical fiber connector according to the present disclosure connected to an optical fiber.

FIG. 5 is an exploded perspective view of the embodiment of FIG. 4, illustrating structural relationships among components of the embodiment.

FIG. 6 is a sectional view of the embodiment of FIG. 4.

FIG. 7 is a perspective view of a housing of the embodiment.

FIG. 8 is an exploded perspective view of two seat members of the housing seen from an angle different from FIG. 7.

FIG. 9 is a perspective view of a tail sleeve of the embodiment.

FIG. 10 is a perspective view illustrating an auxiliary member of the embodiment.

FIG. 11 is a fragmentary sectional view of the embodiment, illustrating the tail sleeve driving the auxiliary member to move therewith.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

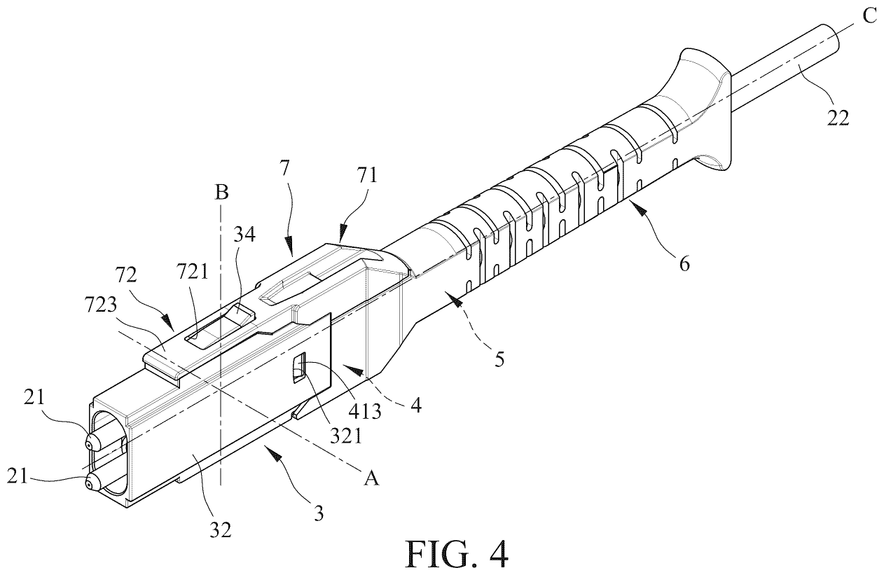

Referring to FIGS. 4 to 6, an embodiment of an optical fiber connector according to the present disclosure is adapted to be connected to two core heads 21 and an optical fiber 22. The optical fiber 22 has two strands respectively connected to the core heads 21. The optical fiber connector includes a casing body 3, a housing 4 removably mounted to the casing body 3, a protective sleeve 5 sleeved on a connecting portion of the housing 4, a tail sleeve 6 mounted to the housing 4 and covering the protective sleeve 5, and an auxiliary member 7 mounted on the tail sleeve 6.

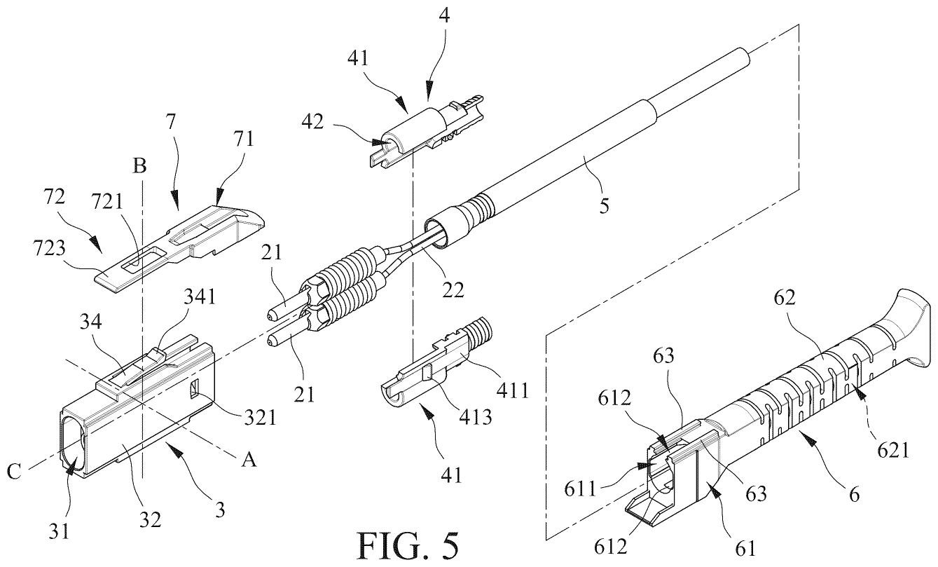

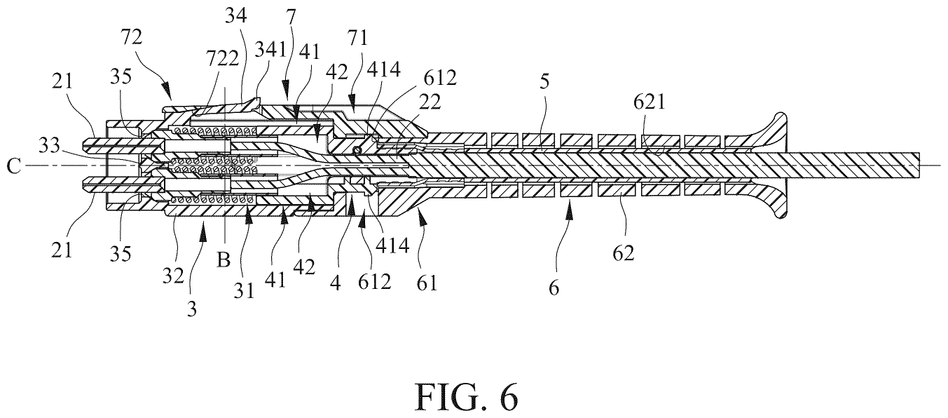

The casing body 3 includes a case wall portion 32 defining an accommodating space 31 therein, a partition portion 33 (see FIG. 6) disposed in the accommodating space 31 and connected to the case wall portion 32, and an engaging portion 34 extending inclinedly from the case wall portion 32 away from the accommodating space 31 and being flexible. The case wall portion 32 is formed with two engaging openings 321 (only one is visible in FIGS. 4 and 5) spaced apart from each other along a width axis (A) and extending through the case wall portion 32 along the width axis (A). The partition portion 33 and the case wall portion 32 cooperatively define two insertion holes 35 in spatial communication with the accommodating space 31 and arranged along a height axis (B) perpendicular to the width axis (A). The engaging portion 34 extends substantially along a longitudinal axis (C) perpendicular to the height axis (B) and the width axis (A), and has a distal end 341 distal from and movable relative to the case wall portion 32 along the height axis (B).

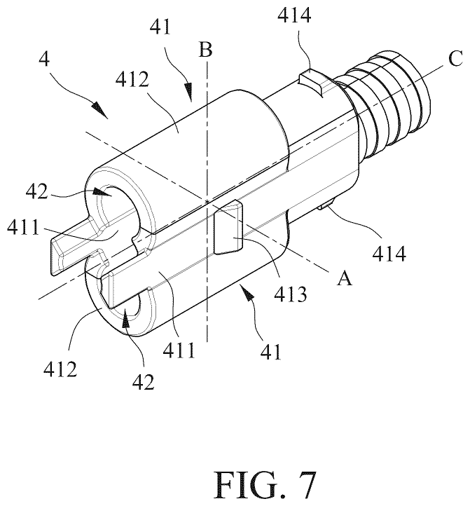

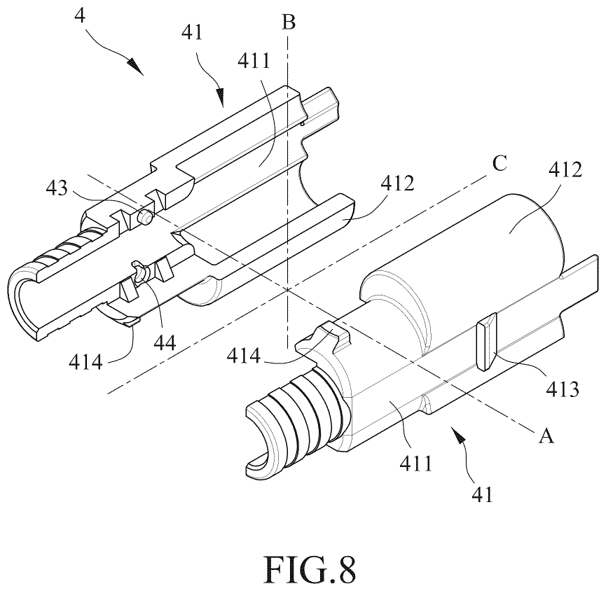

Further referring to FIGS. 7 and 8, the structure of the housing 4 is illustrated in different angles of view. FIG. 8 is an exploded perspective view of the housing 4 from an angle opposite to that of FIG. 7 along the longitudinal axis (C). The housing 4 includes two seat members 41 removably mounted to the casing body 3 and detachably connected to each other. Each of the seat members 41 has a side wall portion 411 extending along the longitudinal axis (C), a tube wall portion 412 connected to the side wall portion 411 and arcuately extending about the longitudinal axis (C), a fastener portion 413 protruding outwardly from the side wall portion 411 along the width axis (A) and engaging a respective one of the engaging openings 321 (see FIG. 4), and a slide piece portion 414 extending outwardly from the side wall portion 411 along the height axis (B). The side wall portions 411 of the seat members 41 have some sections disposed in the accommodating space 31, and some other sections disposed in the tail sleeve 6. The side wall portion 411 of one of the seat members 41 and the side wall portion 411 of another one of the seat members 41 are connected to each other, and are arranged along the width axis (A). In this embodiment, each of the seat members 41 has a tenon 43 and a mortise 44. The tenon 43 of one of the seat members 41 engages the mortise 44 of the another one of the seat members 41, but the manner for connecting the seat members 41 is not limited hereto. The tube wall portion 412 of each of the seat members 41 abuts against and cooperates with the side wall portion 411 of the another one of the seat members 41 to define a mounting groove 42 that extends along the longitudinal axis (C). The fastener portions 413 of the seat members 41 protrude away from the mounting grooves 42. The mounting grooves 42 of the seat members 41 are arranged along the height axis (B), are in spatial communication with the accommodating space 31, and are respectively aligned with the insertion holes 35 along the longitudinal axis (C).

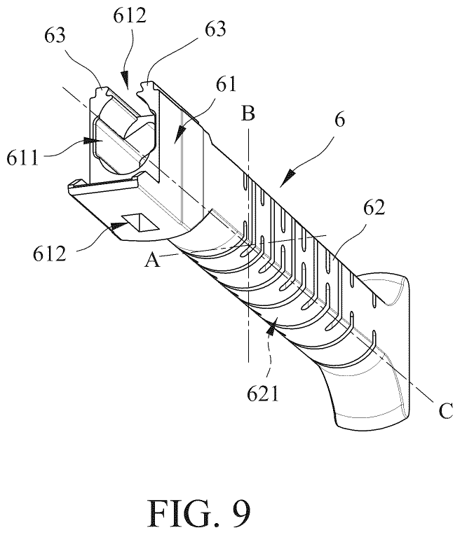

As shown in FIGS. 5 and 6, the protective sleeve 5 is sleeved on the side wall portions 411 of the seat members 41 and is away from the casing body 3 along the longitudinal axis (C). Further referring to FIG. 9, the tail sleeve 6 includes a receiving portion 61 mounted to the seat members 41 and slidable along the longitudinal axis (C), a cover portion 62 extending from the receiving portion 61 along the longitudinal axis (C) in a direction away from the casing body 3, and two slide rail portions 63 spaced apart from each other along the width axis (A), protruding from the receiving portion 61 along the height axis (B), and extending in the direction of the longitudinal axis (C). The receiving portion 61 defines an interior space 611 extending along the longitudinal axis (C), and is formed with two slide grooves 612 spaced apart from each other along the height axis (B), extending in the direction of the longitudinal axis (C), and in spatial communication with the interior space 611. The sections of the side wall portions 411 that are not disposed in the accommodating space 31, and a portion of the protective sleeve 5 that is sleeved on the side wall portions 411 are both disposed in the interior space 611. One of the slide grooves 612 is disposed between the slide rail portions 63 along the width axis (A). The slide piece portion 414 of each of the seat members 41 extends into and is slidable relative to a respective one of the slide grooves 612. The cover portion 62 defines a wire slot 621 extending along the longitudinal axis (C) and in spatial communication with the interior space 611. The protective sleeve 5 has another portion that is not disposed in the interior space 611 and that extends through the wire slot 621 along the longitudinal axis (C).

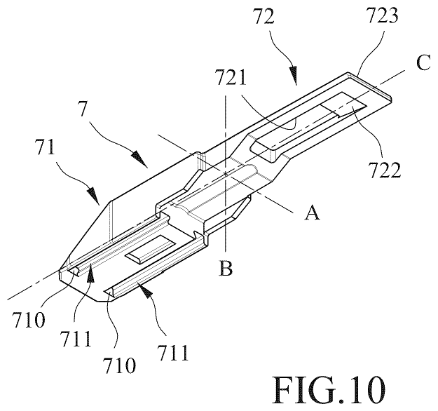

Referring to FIGS. 4 to 6 and 10, the auxiliary member 7 includes a base portion 71 disposed on the slide rail portions 63, and a drive portion 72 extending from the base portion 71 along the longitudinal axis (C). The base portion 71 defines two engaging grooves 711 respectively engaging with the slide rail portions 63. Each of the engaging grooves 711 has a close portion defined by a terminating end surface 710 of the base portion 71 (see FIG. 10), and an open portion closer to the casing body 3 than the close portion along the longitudinal axis (C), such that the base portion 71 is not movable relative to the tail sleeve 6 along the longitudinal axis (C) toward the casing body 3. Furthermore, the cover portion 62 abuts against the base portion 71 and blocks the base portion 71 along the longitudinal axis (C), so that the base portion 71 is prevented from moving relative to the tail sleeve 6 in a direction away from the casing body 3 (i.e., toward the tail sleeve 6) along the longitudinal axis (C). The drive portion 72 defines a slot 721 extending along the longitudinal axis (C), extending through the drive portion 72 along the height axis (B), and detachably engaging with the engaging portion 34. The drive portion 72 has a slide inclined surface 722 abutting against the engaging portion 34, and an outer surface 723 opposite to the slide inclined surface 722 along the height axis (B). A distance between the slide inclined surface 722 and the outer surface 723 along the height axis (B) is gradually reduced along the longitudinal axis (C) in a direction towards the tail sleeve 6 (see FIG. 6). In addition, the slot 721 is closer to the tail sleeve 6 than the slide inclined surface 722 along the longitudinal axis (C).

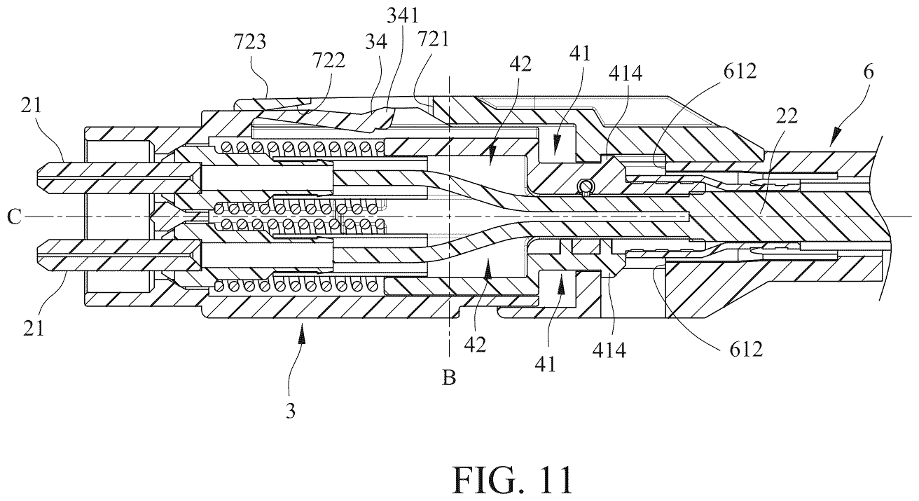

Referring to FIGS. 5 and 6, the optical fiber connector of the embodiment is adapted to be inserted into an optical fiber adapter (not shown) through the distal end 341 of the engaging portion 34. When it is desired to remove the embodiment from the optical fiber adapter, the user only needs to grip the tail sleeve 6 and pull the same along the longitudinal axis (C) away from the casing body 3 so that the receiving portion 61 moves relative to the seat members 41 along the longitudinal axis (C) through sliding movement between the slide grooves 612 and the slide piece portions 414. Subsequently, referring to FIG. 11, when the tail sleeve 6 continuously moves away from the casing body 3, the slide rail portions 63 abut respectively against the terminating end surfaces 710 of the base portion 71 (see FIG. 10), thereby driving the base portion 71 of the auxiliary member 7 to co-move with the tail sleeve 6 away from the casing body 3. At the same time, the drive portion 72 of the auxiliary member 7 co-moves with the base portion 71, such that the slide inclined surface 722 presses the engaging portion 34 and drives the distal end 341 of the engaging portion 34 to move toward the case wall portion (23) along the height axis (B). At this position, the engaging portion 34 is slightly deformed, and the engagement between the distal end 341 of the engaging portion 34 and the slot 721 is loosened to allow the engaging portion 34 to be detached from the optical fiber adapter. In this way, the optical fiber connector of the embodiment may be detached from the optical fiber adapter by continuously pulling the tail sleeve 6 along the longitudinal axis (C) away from the casing body 3. In a case where multiple optical fiber connectors are arranged densely in a matrix in a relatively small space, since any one of the optical fiber connectors can be detached from the optical fiber adapter by pulling the same along the longitudinal axis (C) without operating the same along the width axis (A) and the height axis (B), it is quite simple and convenient for the user to operate without being restricted by the relatively small space.

Referring to FIGS. 5, 6, and 7, to assemble the optical fiber connector 6 and connect the same to the optical fiber 22, the optical fiber 22 is first brought to extend through the protective sleeve 5 and the tail sleeve 6, and the two strands of the optical fiber 22 are respectively inserted in and connected to the core heads 21. Then, in a grinding step, end surfaces of the core heads 21 and end surfaces of the strands of the optical fibers 22 are ground together to reduce reflection angles of optical signal transmitted therein. Next, the core heads 21 are clamped by the seat members 41 from two sides thereof along the width axis (A), so the core heads 21 are respectively received in the mounting grooves 42. Subsequently, the remaining components of the optical fiber connector are assembled, such that the core heads 21 extends outwardly of the insertion holes 35 that are respectively aligned with the mounting grooves 42 along the longitudinal axis (C) through the accommodating space 31. In this way, before the optical fiber connector is completely assembled, grinding quality of the end surfaces of the core heads 21 and the end surfaces of the strands of the optical fiber 22 may be inspected, thereby avoiding the trouble of disassembling the optical fiber connector after assembling the same when the grinding quality is poor. Thus, damage to the optical fiber connector may also be prevented. In addition, by virtue of cooperation of the slide rail portions 63 and the engaging grooves 711 (see FIG. 10), the auxiliary member 7 may be easily mounted to and removed from the tail sleeve 6, which is quite convenient to assemble and dissemble the optical fiber connector.

In summary, in the embodiment of the present disclosure, the engaging portion 34 may be disengaged from the optical fiber adapter by simple pulling of the tail sleeve 6 away from the casing body 3 without breaking any components, which is convenient for the user to operate the optical fiber connector in a relatively small space. Furthermore, since the seat members 41 are designed as two pieces, the core heads 21 and the optical fiber 22 may be ground prior to being clamped between the seat members 41 to be mounted in the optical fiber connector. In this way, the grinding quality of the end surfaces of the core heads 21 and the end surfaces of the strands of the optical fiber 22 may be ensured, thereby preventing damage to the optical fiber connector caused by repeated disassembling and assembling when the grinding quality is poor.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An optical fiber connector comprising:
a casing body that includes
a case wall portion defining an accommodating space therein,
a partition portion disposed in said accommodating space and connected to said case wall portion, and
an engaging portion extending inclinedly from said case wall portion away from said accommodating space, being flexible, extending substantially along a longitudinal axis, and having a distal end that is distal from and movable relative to said case wall portion along a height axis perpendicular to the longitudinal axis, said partition portion and said case wall portion cooperatively defining two insertion holes that are in spatial communication with said accommodating space, and that are arranged along a height axis perpendicular to the longitudinal axis;
a housing that includes two seat members removably mounted to said casing body and detachably connected to each other, said seat members cooperatively defining two mounting grooves that are arranged along the height axis and that are in spatial communication with said accommodating space, said mounting grooves being respectively aligned with said insertion holes along the longitudinal axis;
a tail sleeve that includes
a receiving portion mounted to said seat members and slidable along the longitudinal axis, and
a cover portion extending from said receiving portion along the longitudinal axis in a direction away from said casing body; and
an auxiliary member that includes
a base portion mounted on said tail sleeve, and
a drive portion extending from said base portion along the longitudinal axis and driving movement of said distal end of said engaging portion, said auxiliary member being co-movable with said tail sleeve when said tail sleeve is pulled away from said casing body along the longitudinal axis such that said drive portion drives said distal end of said engaging portion to move toward said case wall portion along the height axis.

2. The optical fiber connector as claimed in claim 1, wherein:
said drive portion of said auxiliary member defines a slot extending along the longitudinal axis, extending through said drive portion along the height axis, and detachably engaging with said engaging portion of said casing body; and
said drive portion has a slide inclined surface abutting against said engaging portion, and an outer surface opposite to said slide inclined surface along the height axis, a distance between said slide inclined surface and said outer surface along the height axis being gradually reduced along the longitudinal axis in a direction towards said tail sleeve, when said base portion of said auxiliary member co-moves with said tail sleeve along the longitudinal axis away from said casing body, said slide inclined surface presses said engaging portion and drives said distal end of said engaging portion to move toward said casing wall portion along the height axis.

3. The optical fiber connector as claimed in claim 2, wherein said slot of said auxiliary member is closer to said tail sleeve than said slide inclined surface along the longitudinal axis.

4. The optical fiber connector as claimed in claim 1, wherein:
said receiving portion of said tail sleeve is formed with two slide grooves spaced apart from each other along the height axis and extending in a direction of the longitudinal axis;
said receiving portion defines an interior space in spatial communication with said slide grooves; and
each of said seat members of said housing has a side wall portion, and a slide piece portion extending from said side wall portion along the height axis, and extending into and slidable relative to a respective one of said slide grooves.

5. The optical fiber connector as claimed in claim 4, wherein:
each of said seat members of said housing further has a tube wall portion connected to said side wall portion and arcuately extending about the longitudinal axis
said side wall portion of one of said seat members and said side wall portion of another one of said seat members are connected to each other and are arranged along a width axis perpendicular to the height axis and the longitudinal axis; and
said tube wall portion of each of said seat members abuts against and cooperates with said side wall portion of said another one of said seat members to define a respective one of said mounting grooves.

6. The optical fiber connector as claimed in claim 5, wherein:
said case wall portion of said casing body is formed with two engaging openings spaced apart from each other along the width axis and extending through said case wall portion along the width axis; and
each of said seat members of said housing further has a fastener portion protrudes from said side wall portion away from said mounting grooves along the width axis and engaging a respective one of said engaging openings.

7. The optical fiber connector as claimed in claim 5, wherein:
said tail sleeve further includes two slide rail portions spaced apart from each other along the width axis, protruding from said receiving portion along the height axis, and extending in the direction of the longitudinal axis;
said base portion of said auxiliary member defines two engaging grooves respectively engaging with said slide rail portions, each of said engaging grooves having a close portion and an open portion that is closer to said casing body than said closed portion along the longitudinal axis;
one of said slide grooves is disposed between said slide rail portions along the width axis; and
said cover portion of said tail sleeve abuts against said base portion of said auxiliary member, and prevents said base portion from moving relative to said tail sleeve along the longitudinal axis.

8. The optical fiber connector as claimed in claim 4, wherein:
said cover portion of said tail sleeve defines a wire slot in spatial communication with said interior space and extending along the longitudinal axis; and
said optical fiber connector further comprises a protective sleeve having a portion that is sleeved on said housing, and that is disposed in said interior space of said tail sleeve, and having another portion that extends through said wire slot along the longitudinal axis.
